(19) United States
(12) Patent Application Publication
(10) Pub. No.: US 2009/0126540 A1
(43) Pub. Date: May 21, 2009

(54) Locking pliers with opposing handle

(76) Inventor: Paul Kammermeier, Boulder, CO (US)

Correspondence Address: R. Ruschena Patent Agent, LLC, 8400 E. Crescent Parkway, Suite 600, Greenwood Village, CO, 80111, US

(21) Appl. No.: 12/290,519

(22) Filed: Oct. 31, 2008

Related U.S. Application Data
(60) Provisional application No. 61/001,151, filed on Oct. 31, 2007.

(51) Int. Cl. B25B 7/00

(52) U.S. Cl. 81/427.5

(57) ABSTRACT

The present invention is a pair of locking pliers having an opposing handle extending from the upper jaw or lower jaw of the locking pliers, generally parallel to, and roughly the same length and shape as, the first handle. A user can simultaneously place one hand on the first handle and the other hand on the opposing handle so that there is one handle on each side of the workpiece, allowing the user to apply more rotational force to the workpiece. The invention allows the user to apply pressure and torque more evenly to keep unstable work objects from moving, when not securely fixed. When space around the workpiece compromises the user's reach, the opposing handle provides and additional opportunity to rotate the workpiece. A second embodiment of the invention provides an optional, detachable handle extension securely attached to the upper jaw and/or an optional and detachable handle extension that can be securely attached to first handle of the locking pliers. The invention can also be applied to other similar hand tools such as adjustable pliers, wrenches, socket wrenches, pipe wrenches, or other tools.

### RELATED APPLICATIONS

This application claims priority based on the Provisional Patent Application 61/001,151 filed on Oct. 31, 2007.

### BACKGROUND OF THE INVENTION

1. Field of the Invention

This invention relates to hand tools, and more specifically to a pair of locking pliers with an improved way for the user to grasp it.

Locking pliers typically consist of a pair of pliers with the handles to be the continuation of the upper and lower jaws of the pliers.

This invention provides an additional handle, extending from the upper jaw of the locking pliers so that the user can apply additional rotating force by grasping and rotating the pliers with both hands using two opposing handles instead of one.

2. Brief Description of the Prior Art

Locking pliers typically consist mainly of pliers with the handles to be the continuation of the upper and lower jaws of the pliers. U.S. Pat. No. 6,941,844 to Hile, and U.S. Pat. No. 6,857,342 to Wang are two examples of prior art locking pliers. With this single-sided design, the user must grasp the handles with one hand, or at best, with two hands, both grasping the pliers' handles. In either case, the hand or hands can only apply force on one side of the axis of rotation of the workpiece. The results can be that if the workpiece is not fixed, or it can move, sway or wiggle while being turned; a reduced torque can be applied because there is only one lever arm. If the entrance to the work space is too small, the user may be unable to reach the handle in some parts of its turning arc. This may force the user to unlock the pliers, reposition it, and then re-lock it before rotating the workpiece again. The invention may also aid disabled users.

### SUMMARY OF THE INVENTION

It is with respect to these considerations and others that the present invention has been conceived.

The invention is an improved version of locking pliers, having an opposing handle extending from the upper jaw, roughly parallel to and opposite the locking pliers handle. The opposing handle is actually an extension of the upper jaw or it is securely attached to the upper jaw of the locking pliers. The opposing handle allows a user to grasp the pliers simultaneously with two hands, on opposite sides of the workpiece.

The utility advantages of locking pliers with opposing handle are multiple. Since the opposing handle acts as a second lever arm, the user is able to apply more rotational force to the workpiece. Another great advantage of the invention is to allow the user to more evenly apply the rotating force and thus stabilize the workpiece when turning it, whenever the workpiece is not securely fixed. but tends to move, sway or wiggle when the user attempts to rotate it. Additionally, the locking pliers according to the invention, allow the user to operate in conditions where the work space or the user's reach is limited or obstructed. Once a workpieces is held securely by conventional locking pliers and attempted to be rotated, the handle of the conventional pliers might rotate far enough as to be out of reach of the user. In this case, the user would have to unlock the pliers, reposition them, and then relock them before continuing to rotate the workpiece. Using the locking pliers with opposing handle, according to the present invention, when one handle is turned farther away, the additional handle naturally comes closer, and it can be easier for the user to reach, thus avoiding the need to unlock, reposition, and re-lock the locking pliers. These and various other features as well as advantages, which characterize the present invention, will be apparent from a reading of the following detailed description and a review of the associated drawings.

### BRIEF DESCRIPTION OF THE DRAWINGS

The accompanying drawings, which are incorporated in and constitute a part of the specifications, illustrate two embodiments of the invention, and, together with the description, serve to explain the principles of the invention:

FIG. 1 is a side view of the locking pliers with opposing handle according to the first embodiment.

FIG. 2 is a side view of an additional embodiment of the locking pliers with detachable, optional extensions.

The preferred embodiments of the present invention will be described hereinafter with reference to the accompanying drawings.

### REFERENCE NUMERALS IN DRAWINGS

10 Locking pliers
12 Opposing handle
13 Removable opposing handle
14 Upper jaw
16 Lower jaw
18 Grooves or gnurling
20 First handle
22 Female handle extension
23 Male opposing handle extension
24 Male threads
25 Female threads

### DETAILED DESCRIPTION OF THE PREFERRED EMBODIMENTS

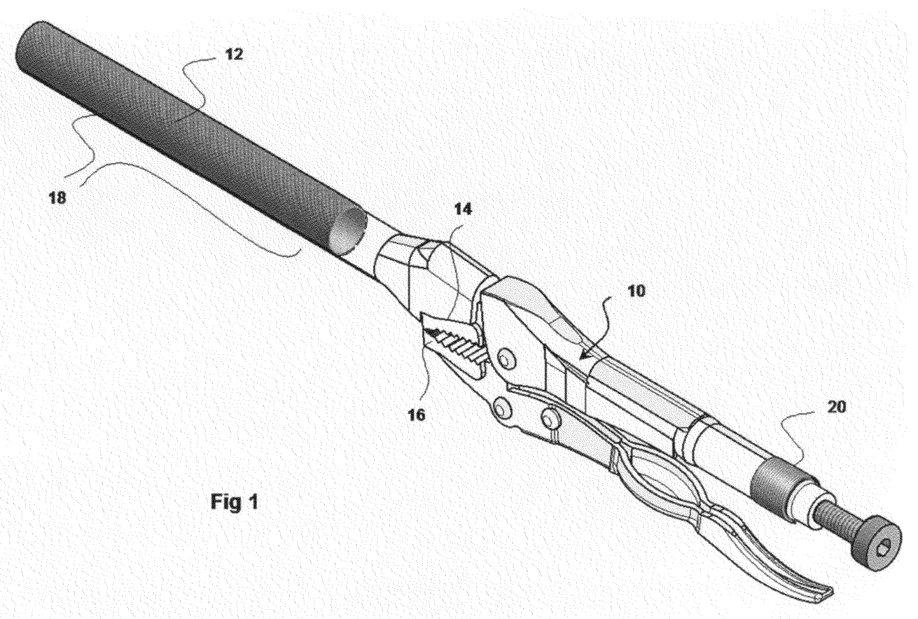

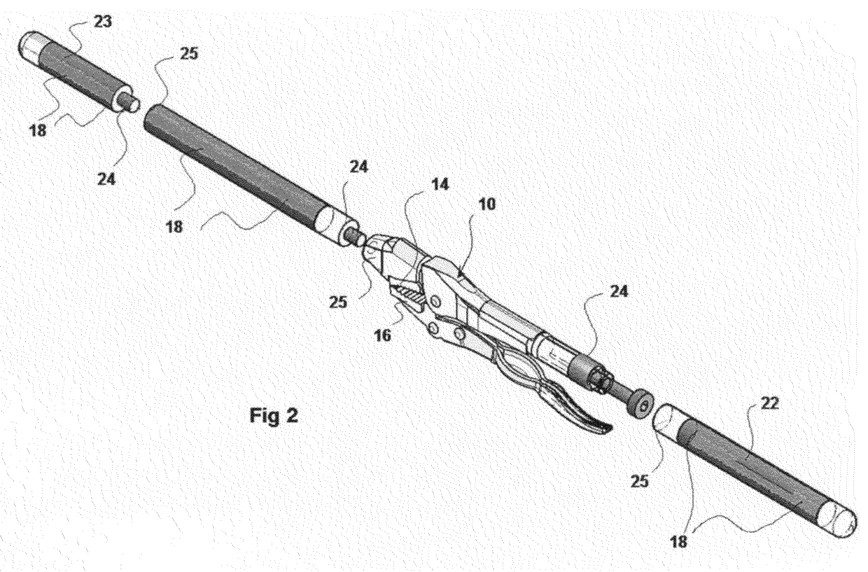

One embodiment of the locking pliers with opposing handle is illustrated in FIG. 1, while FIG. 2 illustrates a second embodiment of the invention. FIG. 1 shows the locking pliers 10, a first handle 20, an upper jaw 14, and a lower jaw 16. In accordance with the invention, upper jaw 14 is extended opposite the first handle 20 to form an opposing handle 12, approximately the same length, size and shape as the first handle 20. The opposing handle 12 has optional grooves or gnurling 18 or added friction material to the surface to facilitate the user's grip. The opposing handle 12, including the optional grooves or gnurling 18, and the upper jaw 14 can be made out of one single piece, or they can be made separately and coupled to the upper jaw 14 by way of a threaded joint or other suitable joint or attachment. Optional grooves or gnurling 18 of the opposing handle 12 can be replaced by covering its surface with various friction materials, such as nylon, plastic, rubber, polyurethane, to increase the strength of the grip of the opposing handle, while rotating the workpiece held by the upper and lower jaws of the locking pliers.

The manner of using the locking pliers with the opposing handle requires the user to initially hold securely a workpiece within the jaws of the locking pliers. The user then holds the locking pliers with one hand positioned on first handle 20 and another hand positioned on the opposing handle 12. Having two hands on the locking pliers simultaneously, gives the user the major advantage of being able to apply greater rotational force around the axis of the workpiece, and a greater leverage since two hands are applying simultaneously the rotational force. Another important advantage, when compared to the simple locking pliers without opposing handle, is that if the workpiece is often not stable, or can wiggle, having two hands on the pliers while rotating the workpiece allows the user to apply pressure and rotational force more evenly, thus providing greater stability. This can minimize the amount of wiggling or other unwanted movements of the workpiece. Often, when space around the workpiece is limited, it may be difficult to use the first handle 20, while the opposing handle 12 can give the user a second, closer handle to use.

FIG. 2 shows a second embodiment of the invention. In this embodiment, the locking pliers have a removable opposing handle 13 that can be securely attached to the upper jaw 14 via a male thread 24 and a female thread 25 or using other means of attachment. In case that additional leverage is needed, the male opposing handle extension 23 can be securely attached to the removable opposing handle 13 via a male thread 24 and a female thread 25 or using other means of attachment. If more leverage is needed, the female handle extension 22 can be securely attached to the first handle 20 via a male thread 24 and a female thread 25 or using other means of attachment.

The female handle extension 22 and the male opposing handle extension 23 increase the length of the first handle 20 and upper jaw 14 to allow the user to increase the leverage and to apply more rotational force to the workpiece.

It is evident by the specification of the invention, that the locking pliers with opposing handle provides the advantage of a more effective, easier to use locking pliers, when compared to conventional locking pliers, by providing the user superior means of grasping the locking pliers more securely and effectively. The opposing handle allows the user to apply an additional rotational force, to stabilize the workpiece, and to provide at the same time a way of overcoming working situations limiting the user's reach.

While the above description of the preferred embodiments of the locking pliers according to the invention contains many specific applications of the opposing handle, these specific applications should not be construed as limitations on the scope of the invention, but rather as exemplifications of the presently preferred embodiments thereof. Other ramifications and variations are possible within the teachings of the invention.

For example, the concept of adding an opposing handle and related extensions can be applied to other hand tools, such as pipe tools, crescent wrenches, and socket wrenches, whenever additional torque or stability is needed.

The opposing handle and handle extensions can have other shapes, such as being curved or having a different cross section, other than cylindrical and they can be wider at the ends than where they are attached to the upper jaw or to the first handle.

The opposing handle or the handle extensions are usually made of the same material as the locking pliers, usually, but not limited, to heavy-duty metals or synthetic materials and can be of different length, usually about the same length of the first handle of the locking pliers.

The opposing handle may extend from the lower jaw of the locking pliers instead of from the upper jaw, or the opposing handle may extend from both jaws.

As described by the second embodiment, the opposing handle, and extensions, whether attached to the upper jaw and/or to the first handle, may be easily removable to allow the user to use the locking pliers according the prior art teaching.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What I claim is:

1. Improved locking pliers for grasping and rotating a workpiece comprising:
an upper jaw (14)
a lower jaw (16),
a first handle (20),
wherein said upper jaw (14) is extended to form an opposing handle (12) whereby said opposing handle (12) enables the operator to:
grasp said locking pliers simultaneously with two hands, one on each side of said workpiece, enabling the operator to apply more rotational force to said workpiece,
stabilize said work piece while rotating it by more evenly applying torque on opposing sides of it,
grasp the additional handle when working conditions limit the user's reach,
overcome certain disabilities or limitation of movements.

2. Improved locking pliers according to claim 1, wherein said upper jaw (14) can be extended by attaching an optional, removable opposing handle (13) to increase the length of said upper jaw (14) to allow the user to apply more rotational force to said workpiece.

3. Improved locking pliers according to claim 2, wherein said removable opposing handle (13) can be extended by attaching an optional male opposing handle extension (23) to further increase the rotational force to said workpiece.

4. Improved locking pliers according to claim 1 wherein said first handle (20) can be extended by attaching an optional, female handle extension (22) to allow the user to apply more rotational force to said workpiece,

5. Improved locking pliers according to claim 1 wherein said opposing handle (12) has grooves or gnurling applied to the surface.

6. Improved locking pliers according to claim 1 wherein said opposing handle (12) is covered by a material selected from the group consisting of nylon, plastic, rubber and polyurethane to improve the user's grip.
